(19) United States
(12) Patent Application Publication
(10) Pub. No.: US 2025/0284144 A1
(43) Pub. Date: Sep. 11, 2025

(54) EYEWEAR WITH FRONT FRAME REMOVABLY ATTACHABLE TO BASE EYEWEAR BY ENHANCED MAGNETS

(71) Applicant: Pair Eyewear, Inc., New York, NY (US)

(72) Inventors: Philip Denton Gordon, Ladera Ranch, CA (US); William Scott Craycraft, Trabuco Canyon, CA (US)

(21) Appl. No.: 19/070,145

(22) Filed: Mar. 4, 2025

Related U.S. Application Data
(60) Provisional application No. 63/562,562, filed on Mar. 7, 2024.

(51) Int. Cl. G02C 11/02; G02C 5/00; G02C 5/22

(52) U.S. Cl. CPC G02C 11/02; G02C 5/008; G02C 5/22; G02C 2200/02; G02C 2200/08

(57) ABSTRACT

An eyewear system can include a base frame with a front portion comprising an anterior surface and a posterior surface, at least one lens, and left and right ear stems attached to the front portion of the base frame; and a front frame configured to be positioned in front of the front portion of the base frame; and wherein the front frame is releasably connectable to the base frame by a plurality of magnetic couplings, each of the plurality of magnetic couplings comprising at least one magnet with an exposed external surface and a recessed internal surface on an opposite side, the exposed external surface having a smaller width than the recessed internal surface.

### RELATED APPLICATIONS

This application claims the benefit of U.S. Provisional Patent Application No. 63/562,562, filed on Mar. 7, 2024, which is incorporated by reference and made a part of this specification for all that it discloses. This application also incorporates by reference and makes a part of this specification for all that it discloses U.S. Pat. No. 11,762,223, issued on Sep. 19, 2023, and entitled “Removably Attachable Top Frame For Eyewear.”

### BACKGROUND

The present disclosure relates generally to eyewear with two or more parts that removably attach to each other.

### SUMMARY

In some embodiments, an eyewear system can include a base frame with a front portion comprising an anterior surface and a posterior surface, the front portion comprising a left lens orbital carrying a left lens and a right lens orbital carrying a right lens. The eyewear system can include left and right earstems attached to the front portion of the base frame. The eyewear system can also include a front frame with left and right openings, the front frame being configured to be positioned in front of the left and right orbitals while exposing the left and right lenses through the left and right openings. The front frame can be releasably connectable to the base frame by a plurality of magnetic couplings, each magnet coupling being formed by at least a pair of magnets. At least one or a plurality of each pair of magnets can include an exposed surface and a recessed internal surface on an opposite side. The width or surface area of this exposed external surface can be smaller than the recessed internal surface of the magnet, such as when the magnet is trapezoidal or conical. Many other shapes are possible with smaller exposed external surfaces than recessed opposing surfaces on the same magnet.

In some embodiments, an eyewear system can include a base frame having a front portion with an anterior surface and a posterior surface. The front portion can have a left lens orbital carrying a left lens and a right lens orbital carrying a right lens. The base frame can include left and right earstems attached to the front portion of the base frame. The front frame can have left and right openings, the front frame being configured to be positioned in front of the left and right orbitals while exposing the left and right lenses through the left and right openings. The front frame can be releasably connectable to the base frame by a plurality of magnetic couplings. At least one or both of the magnet couplings can include at least one magnet and a ferromagnetic guide in the form of a plate positioned in a recess in either the base frame or the front frame, the plate positioned behind or further within the recess than the magnet. In some eyewear, the ferromagnetic guide is integrated into a component in the eyewear system that performs another eyewear function, such as being part of a hinge stake.

In some embodiments, an eyewear system can include a base frame with a front portion comprising an anterior surface and a posterior surface. The front portion can include a left lens orbital carrying a left lens and a right lens orbital carrying a right lens. The base frame can include left and right earstems attached to the front portion of the base frame. The eyewear system can also include a front frame with left and right openings, the front frame being configured to be positioned in front of the left and right orbitals while exposing the left and right lenses through the left and right openings. The front frame can be releasably connectable to the base frame by a plurality of magnetic couplings, each coupling can have a first magnetic region with a first array of permanent magnets adjacent to each other positioned in a recess on one of the front frame or the base frame, and a corresponding second magnetic region with a second array of permanent magnets adjacent to each other positioned in a recess on the other of the front frame or the base frame, the second array of permanent magnets having polarities configured to produce an attractive force with the first array of permanent magnets.

Some of the embodiments as described herein are beneficial for producing a magnetic field that is closer to the magnet or that has lower depth, thereby reducing the risk that the magnetic field interferes with magnetized devices or devices sensitive to magnetics such as, but not limited to, credit cards, security badges or other magnetic strip cards, sensitive data surfaces, hard drives, monitors or TVs, mobile phones or tablets, and mechanical watches. Furthermore, some or all of the embodiments as described herein can be advantageous for providing a magnetic circuit that is controllable and compact.

### BRIEF DESCRIPTION OF THE DRAWINGS

FIG. 1 is a rear perspective, exploded view of an example of an eyewear with a base frame and a front frame.

FIG. 2 is a front perspective, exploded view of the eyewear of FIG. 1.

FIG. 3 is a front elevational view of the eyewear of FIG. 1, spaced vertically apart.

FIG. 4 is a top plan view of the eyewear of FIG. 1, and FIG. 4A is another top plan view of another embodiment of eyewear.

FIG. 5 is an enlarged top plan view of a horizontal cross-section of a lateral portion of the eyewear of FIG. 1, shown in an as-mounted configuration. The opposite lateral portion (not shown) in each of the figures of this type can be a mirror image.

FIG. 5A is another embodiment of an enlarged top plan view of a horizontal cross-section of a lateral portion of the eyewear of FIG. 1 with a pair of trapezoidal permanent magnets.

FIG. 5B is an illustration of three examples of magnetic fields generated by permanent magnets, alone or interacting with each other.

FIG. 5C is another embodiment of an enlarged top plan view of a horizontal cross-section of a lateral portion of the eyewear of FIG. 1 with a pair of permanent magnets with magnetic field guides.

FIG. 5D is another embodiment of an enlarged top plan view of a horizontal cross-section of a lateral portion of the eyewear of FIG. 1 with a magnetic field guide integrated into a schematically represented hinge stake.

FIG. 5E is another embodiment of an enlarged top plan view of a horizontal cross-section of a lateral portion of the eyewear of FIG. 1 with a pair of arrays of permanent magnets.

FIG. 5F is a series of partial illustrations of eyewear with lens orbitals comprising various examples of arrays of permanent magnets.

FIG. 5G is an example of a magnetic array embedded into a partially illustrated anterior surface of an orbital of a base frame of an eyewear that is configured to be removably attachable to a corresponding oppositely oriented magnetic array in the posterior surface of an orbital of a front frame of an eyewear (not shown).

FIG. 5H is an illustration of a magnetic field generated by the magnetic array of FIG. 5G.

FIG. 6 shows an array of top frames having unique aesthetic anterior surfaces.

### DETAILED DESCRIPTION

While the present description sets forth specific details of various embodiments, it will be appreciated that the description is illustrative only and should not be construed in any way as limiting. Additionally, it is contemplated that although the front frames and the base frames of the eyewear are primarily disclosed in the context of dual-lens eyewear systems, such features can be implemented in both unitary and dual-lens eyewear systems, helmets, goggles, hats, caps, or any other wearable articles or devices.

Any structure, feature, composition, method, or step that is illustrated and/or described in any embodiment in this specification (including in U.S. Pat. No. 11,762,223) can be used by itself or with or instead of any other structure, feature, composition, method, or step that is illustrated and/or described in any other embodiment or that is known in the art. In accordance with the ordinary meaning in this field, the terms “eyewear” and “eyeglass” encompass products with any type of lens or lenses, including glass or plastic lenses. No feature illustrated and/or described in any embodiment is indispensable or essential. The relative proportions and sizes of all components illustrated in the accompanying drawings are intended to form part of the supporting disclosure of this specification but should not be considered limiting except to the extent that these relative proportions and/or sizes are expressly recited in a particular claim.

Although particular embodiments may be disclosed or shown in the context of frames (e.g., base frames or front frames) having full orbitals, such embodiments can be used with frames having partial orbitals or rimless frames. Furthermore, various applications of features disclosed herein and modifications thereto, which may occur to those who are skilled in the art in view of the present disclosure, are also encompassed by the scope of the present invention.

Some embodiments enable a wearer to selectively, reversibly modify, or personalize their eyeglasses to exhibit any of a variety of decorative aesthetics and/or informational content. In some embodiments, one or more aesthetic modifications to the eyeglasses do not affect the stability or optical quality of the eyewear. For example, the front frame can not only be easily incorporated into the eyewear but can also be securely retained by the eyewear without affecting the optical quality or fit of the eyewear.

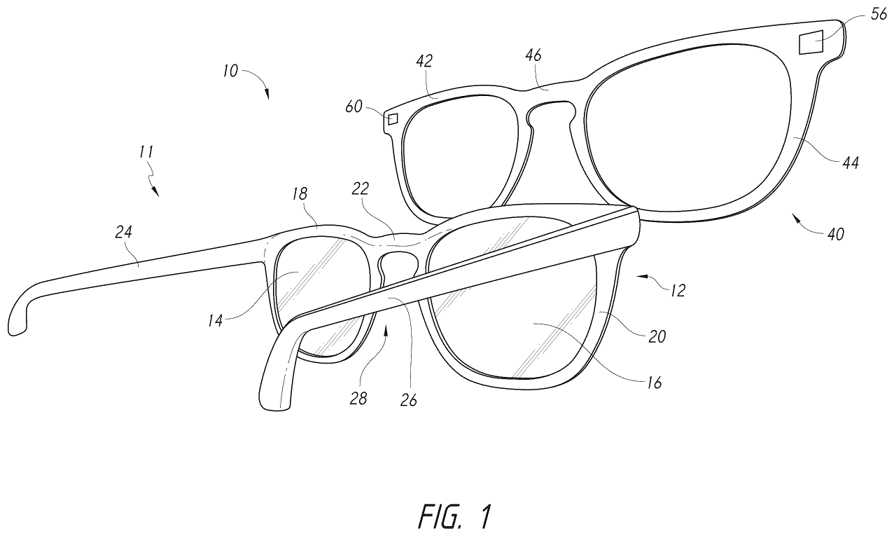

Referring to FIG. 1, in some embodiments, the eyewear 10 generally comprises a base frame 11 that comprises a front portion 12 which, in the illustrated embodiment, supports a left lens 14 and a right lens 16, and a pair of earstems 24, 26. Although the illustrated examples are shown as a dual-lens system, it is to be understood that the features, structure, methods, and/or principles discussed herein are readily applicable to the production of frames for a wide variety of eyewear including unitary lens eyewear systems and protective goggle and helmet systems as well. The eyewear 10 may also include a front frame 40 that is configured to removably attach to at least one surface of the base frame 11. In some embodiments, the front frame 40 may not include any lenses, thereby fully exposing the lens or lenses of the base frame 11, without providing any additional optical alteration or additional protection or barrier. In some embodiments, the front frame 40 can include a lens or lenses that may cover, protect, and/or modify one or more optical characteristics of, the lens or lenses of the base frame 11.

In some embodiments, any part of the eyewear 10, including the front portion 12 of the base frame 11, and/or the front frame 40, may be formed of any suitable material, such as a polymer or plastic material (e.g., TR90, cellulose acetate, cellulose acetate propionate, xylonite, nylon, blended nylon), a metal material (e.g., aluminum, stainless steel, iron, titanium, etc.), and/or a composite material (e.g., carbon fiber). Frames that include polymer or plastic material may provide various advantages, such as high malleability or deformability during assembly of the lens to the frame, low cost, low weight of the frame, and/or many varieties in colors and style, etc.

The example of eyewear shown in the figures is dual-lens eyewear, but anything shown or described in this specification can be used with appropriate adjustments in any other eyewear, such as an eyewear shield system or a single-lens or monolens eyewear. The example of eyewear shown in the figures comprises lens-receiving regions with orbitals that are closed, integral, and unitary with the rest of the front face of the eyewear. The example orbitals are closed in that each orbital fully surrounds the inserted lens. A closed orbital can be formed of one or more separate pieces connected together (not shown). The example orbitals are integral in that they are formed of a single piece of material, without requiring connectors to attach components of the orbital to each other during insertion or removal of a lens. The example orbitals are unitary with the rest of the front face 12 of the eyewear 10 in that they are formed of a single piece of material with the rest of the front face 12 of the eyewear 10, without requiring connectors to attach the orbitals to the rest of the front face 12 of the eyewear 10. Many other structures and configurations can be used instead of or in addition to those illustrated in the examples. The orbitals 18, 20 illustrated and/or described are examples. Any suitable lens-receiving region can be used, whether or not it is an orbital with these features, or whether or not it is an orbital at all.

The lens(es) 14, 16, shield, or other optical barrier or optically enhancing component, used in the eyewear can be of any suitable type: plano, ophthalmic or prescription, spherical, cylindrical, toroidal, darkening or light-attenuating, UV-protecting, polarizing, molded to shape, cut from lens blanks, interference-layer coated, anti-scratch, antiglare, antireflective, antifog, and/or any other type of lenses. In some embodiments, the lens(es), shield, or other optical barrier or optically enhancing component is or are formed of a suitable material such as plastic (e.g., polycarbonate), glass, or any other material suitable for a particular application or use.

The front portion 12 of the base frame 11 generally comprises a first orbital 18 and a second orbital 20 for supporting the first lens 14 and second lens 16. Although the illustrated embodiments are shown in the context of a pair of orbitals 18 and 20 which surround the respective lenses, anything in this specification can be adjusted to apply to eyewear systems in which the frame only partially surrounds the lens or lenses, or contacts only one edge or a portion of one edge of the lens or each lens as well. In the illustrated embodiment, the orbitals 18 and 20 are connected by a bridge 22.

The eyeglass 10 is also provided with a pair of earstems 24 and 26 generally extending rearwardly from the front frame 12 for retaining the eyeglass on the head of the wearer. In addition, an open region 28 is adapted to receive the nose of the wearer. Nose region 28 may optionally be provided with a nosepiece, either connected to the lens orbitals 18 and 20, or the bridge 22, or directly to the lens(s) depending upon the particular embodiment. In some embodiments, the nosepiece may be formed by appropriately sculpting or shaping the medial edges of the orbitals and lower edge of the bridge 22.

In some embodiments, at least the orbitals 18 and 20, and the bridge 22, as well as other non-optical components of the eyeglass system, are manufactured from a high structural integrity material such as through an injection molding or casting process to provide high structural stability in at least the optical support portion of the final product. The orbitals 18 and 20 can be separately formed and assembled later with a separately manufactured bridge 22, or the orbitals 18, 20, and bridge 22 can be integrally formed such as by molding or casting in an integral unit.

In some embodiments, the earstems 24 and 26 are constructed in a manner that permits at least medial and lateral direction flexibility, to enhance the comfort for the wearer and accommodate a variety of head widths. Flexibility of the rearwardly extending ends of earstems 24 and 26 in the desired medial and lateral directions can be accomplished either through the use of flexible construction materials for the earstem, or through the use of relatively rigid earstems in combination with a spring, resilient hinge materials, compressible materials or other techniques which can be used to impart some flexibility and even a medial bias. In some embodiments, earstems 24 and 26 are connected directly or indirectly to the orbitals 18 and 20 through the use of hinges. However, non-hinged flexible or inflexible connections may also be used as desired.

Each orbital 18, 20 may be provided with an annular seat for receiving the lens 14, 16. The annular seat can be formed by the sidewalls of a channel extending radially outwardly into the orbital for surrounding the edge and a portion of the front and rear surface of the lens. In some embodiments, the seat may be formed by the posterior or anterior surface of an annular shelf for receiving the lens from the front or rear side of the eyewear.

The lenses 14, 16 may be retained in the front portion 12 of the base frame 11 in any of a variety of manners, depending upon the configuration of the orbital 18. 20. For example, in the illustrated embodiment, the lenses 14, 16 can be sufficiently flexible to be deformed and force-fit into the annular recess without changing the optics and/or fit of the eyewear 10 in any functionally significant manner.

A front frame 40 is configured to removably attach to an anterior surface of the front portion 12 of the base frame 11. In some embodiments, as illustrated, the front frame 40 can comprise a first front frame orbital 42 connected to a second front frame orbital 44 by a front frame bridge 46. The front frame 40 may be provided with one or more optical elements, such as first and second lenses, filters, or other structures in the wearer's field of view through the orbitals. In some embodiments, the one or more optical elements in the front frame 40 can include any of the optical features described anywhere in this specification, including but not limited to one or more of light intensity attenuation (sun lenses), polarizing, and/or optical correction (ophthalmic or prescription lenses). However, as illustrated, the orbitals 42, 44 of the front frame 40 are open, empty, or unimpeded, without any lens or other structure within the orbitals 42, 44. In some embodiments, the front frame 40 can function solely to provide aesthetic, decorative, expressive, electronic, and/or informational content or capability on the anterior surface of the non-optical surfaces of the eyewear 10.

In some embodiments, the front frame 40 can enable one or more electronic functions in the eyewear, such as by providing one or more of a camera, microphone, laser pointer, flashlight, temperature sensor, electronic display of information or images to the wearer (e.g., virtual reality or augmented reality), electronic outward display (e.g., flashing lights or customizable electronically-generated color), active electronic light attenuation control in one or more lenses on the front frame 40, solar power generator, battery, antenna, modem, wireless communicator, memory, and/or computer processor. In some embodiments, one or more of these components and/or features can be provided in the front frame 40 and one or more of these components and/or features can be provided in the base frame 11 with an electronic coupling, connection, or communication line, such as one or more wires or other conductors, extending between the front frame 40 and the base frame 11 when coupled together. An electronically enabled eyewear 10 can include a front frame 40 that is heavier than in a non-electronic eyewear 10, thus requiring increased coupling force to retain the front frame 40 on the base eyewear 11.

In some embodiments, providing a front frame 40 without a lens or lenses, and/or without electronics, can allow the focus of the product to be on the aesthetic design and fit of the part and/or can decrease the weight of the front frame 40, which can make the eyewear 10 less difficult or burdensome to carry, store, and/or wear.

One or more or all of the dimensions and configuration of the anterior surface of the front frame 40 can generally match, correspond to, align with, and/or be substantially equal to one or a plurality of the dimensions and configuration of the front portion 12 of the base frame 11. For example, in some embodiments, the outermost perimeter and/or shape of the front frame 40 can generally match, correspond to, align with, and/or be substantially equal to the outermost perimeter and/or shape of the front portion 12 of the base frame 11. In some embodiments, the outermost perimeter of the front frame 40 does not extend outwardly beyond at any point the outermost perimeter of the front portion 12 of the base frame 11. As shown, in some embodiments, one or more of these features can allow the front frame 40 to be secured to the anterior surface of the front portion 12 of the base frame 11 in a manner that gives the appearance of a unitary eyeglass frame, without a part line between the front portion 12 of the base frame 11 and the front frame 40 when viewed from the side, and/or without the front portion 12 of the base frame 11 being visible behind the front frame 40 when viewed from the front.

A selection of multiple front frames 40 may be provided for interchangeable connection to any given front frame. The selection may include a plurality of front frames 40 that are geometrically identical to each other or that have generally the same shape, differing only by aesthetic or graphic content on at least the anterior and/or the peripheral surface. Artistic content may include one or more solid colors, geometric or random patterned colors, graphical images or designs, and/or written material such as logos, symbols, or printed words. The appearance of the front frame 40 can be different from the appearance of the front portion 12 of the base frame 11 in color, brightness, print patterns, and/or other artistic features. In some embodiments, a selection of front frames 40 can be provided for the same base frame 11, including one or more front frames 40 with different aesthetic appearances from each other and from the front portion 12 of the base frame 11, and/or one or more front frames 40 with different optical features from each other and from the front portion 12 of the base frame 11, and/or one or more front frames that enable, supplement, or complement electronic functionality in the eyewear 10 when coupled with the base frame 11.

As illustrated in FIG. 1, the front frame 40 is configured to be releasably secured to the corresponding front portion 12 of the base eyewear, enabling the wearer to select from a collection of a plurality of top frames 40 based upon aesthetic content, and/or optical or electronic functionality, and easily and quickly customize the appearance and/or functionality of the eyewear 10. In some embodiments, this can give the wearer the ability to repeatedly customize appearances or electronic functionality, without incurring the expense of buying redundant underlying ophthalmic or other types of eyewear.

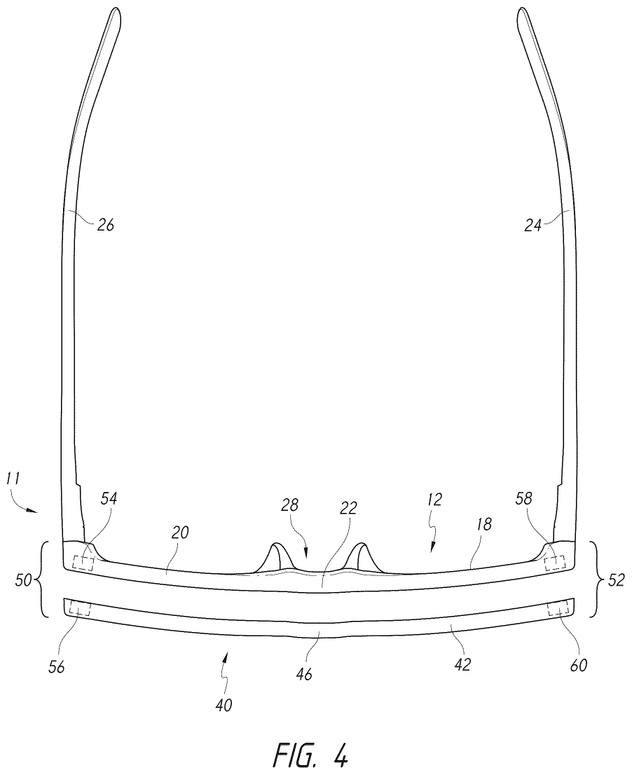

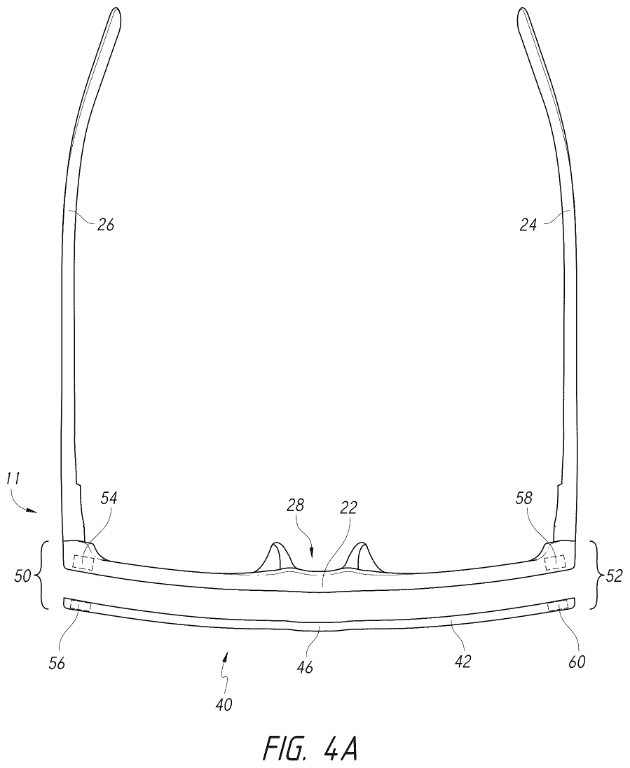

Referring to FIG. 4, at least one, and preferably two or three or four or more connectors may be provided to releasably couple the front frame 40 with the front portion 12 of the base frame 11. Each of the connectors can comprise a first component on the front portion 12 of the base frame 11 and a second component on the front frame 40. In the illustrated implementation, a first connector 50 is provided at a first lateral side of the eyewear 10 and a second connector 52 is provided at an opposing second lateral side of the eyewear 10. As shown, in some embodiments, the first and second connectors 50, 52 are respectively provided in the lateral upper corners or regions of the respective front portion 12 of the base eyewear and the front frame 40, very close to the upper and outer lateral edges of the front frame 40 and/or the front portion 12 of the base frame 11.

For example, as illustrated, the distances between the first and second connectors 50, 52 and the respective upper and outer lateral edges of the front frame 40 and/or the front portion 12 of the base frame 11 can be about the same as and/or less than or equal to: (a) about the amount of a thickness along one or more of the orbitals 18, 20, 42, 44 (e.g., a minimum thickness) in a region spaced away from the connectors 50, 52; and/or (b) about the amount of a thickness along one or more of the bridges 22, 46 (e.g., a minimum thickness). In some embodiments, as shown, there are no connectors provided or positioned between the first and second connectors 50, 52 on the front portion 12 of the base frame 11, and/or there are no other connectors anywhere on the front portion 12 of the base frame 11 for attaching the front frame 40 to the front portion 12 of the base frame 11 besides the upper lateral connectors 50, 52.

Any of a variety of one or more connectors may be utilized, depending upon the desired performance. For example, one or more mechanical couplings can be provided, such as complementary pins and recesses, screws and complementary threaded apertures, or deflectable lever arms having a lateral projection for providing an interference fit with the complementary base or top frame, for example, may be used.

In some embodiments, as illustrated, the connector system comprises a plurality of magnetic couplings. In some embodiments, the magnetic attachment force of the magnetic couplings can be improved by: (a) selecting a magnetic-field enhancing shape for one or more of the individual magnets; (b) providing a magnetic field guide (which in some embodiments can perform one or more additional functions in the eyewear, such as with a magnetic field guide that is also a hinge or earstem connector); and/or (c) providing an array of closely positioned magnets arranged on the same side of a particular magnetic coupling in such a way that the polar alignment of the individual magnets within the array can function to narrow and intensify the magnetic field lines in the region of magnetic attachment with a corresponding and opposing array of magnets on the opposite side of the magnetic coupling.

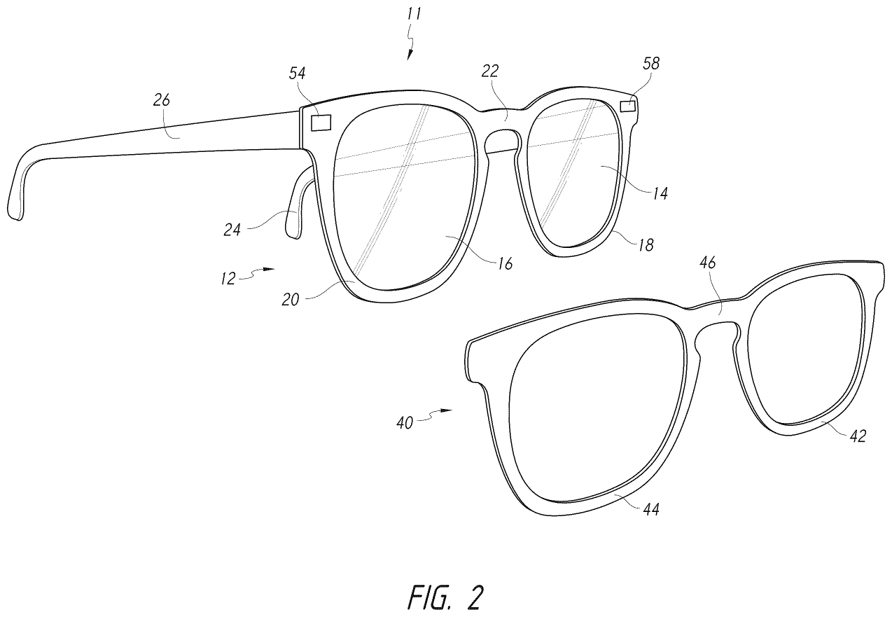

In FIGS. 1, 2, 3, 4, 4A, and 5, the components of the magnetic couplings are shown schematically. Any of the magnetic couplings that are disclosed and/or illustrated anywhere in this application or known to those of skill in this field can be used in these embodiments. In some embodiments, the magnetic couplings can be formed between two identical or similarly shaped magnets (e.g., generally square, generally rectangular, generally circular, off-set generally circular portions, generally conical, and/or generally trapezoidal, etc.).

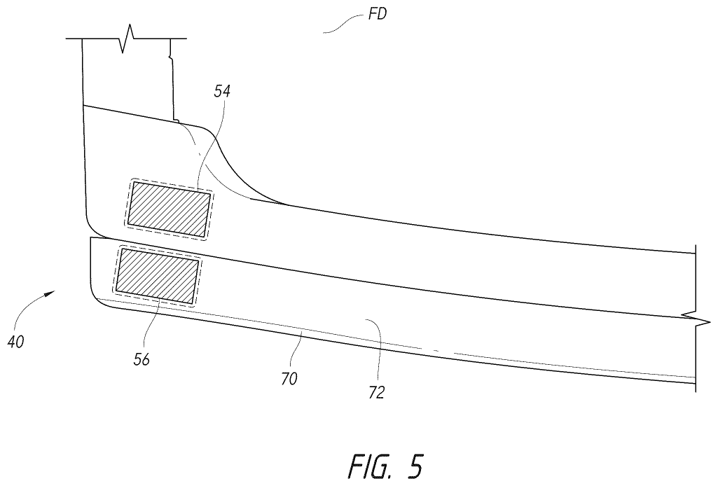

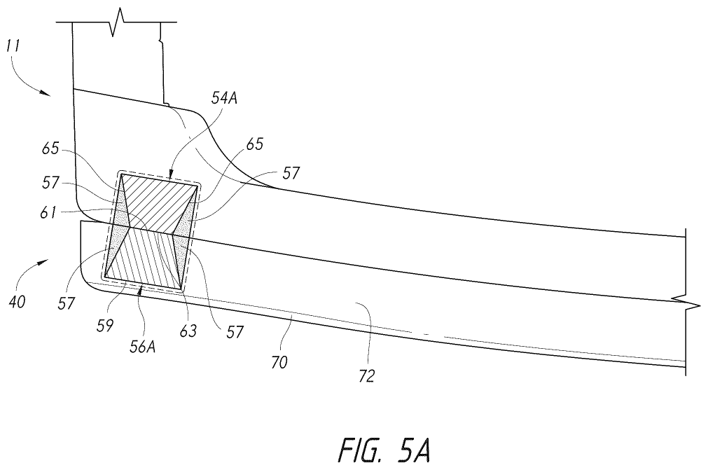

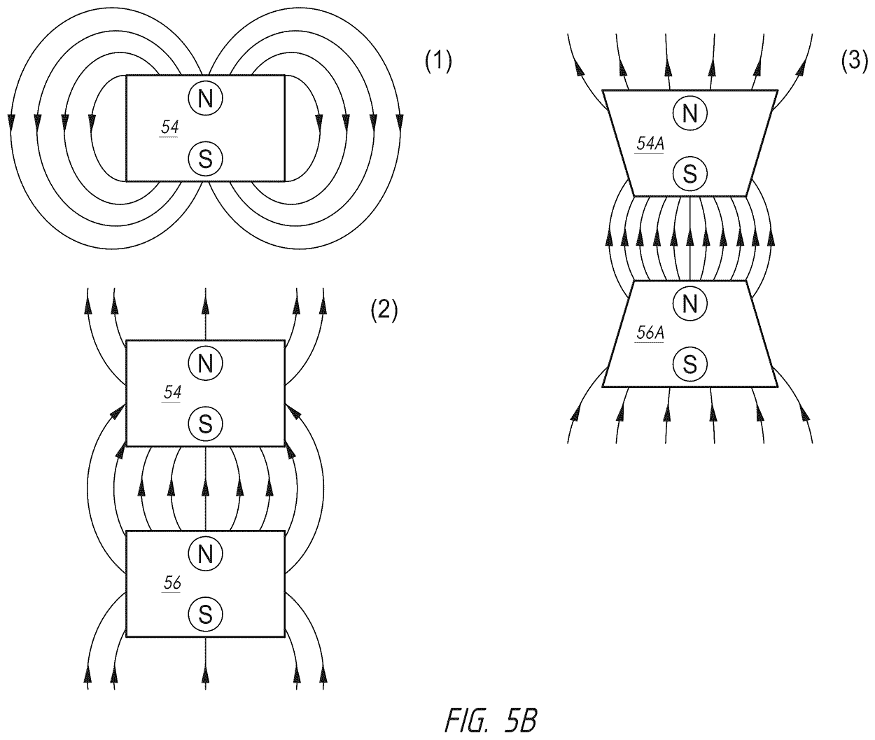

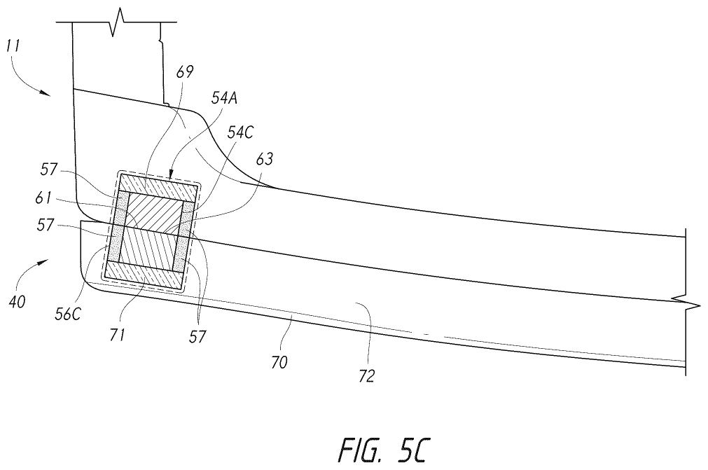

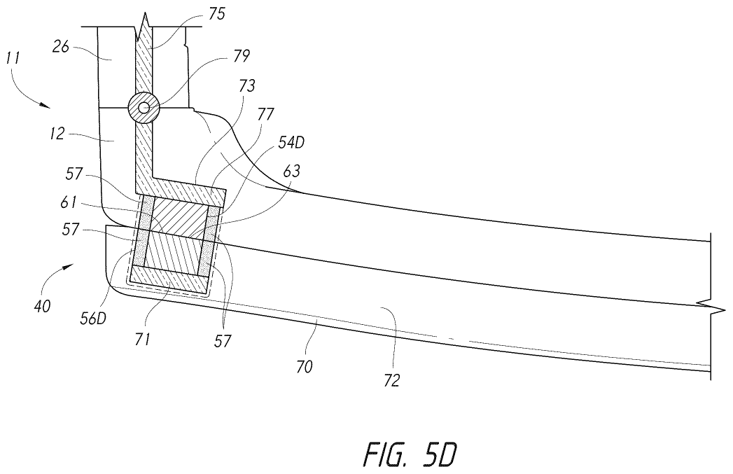

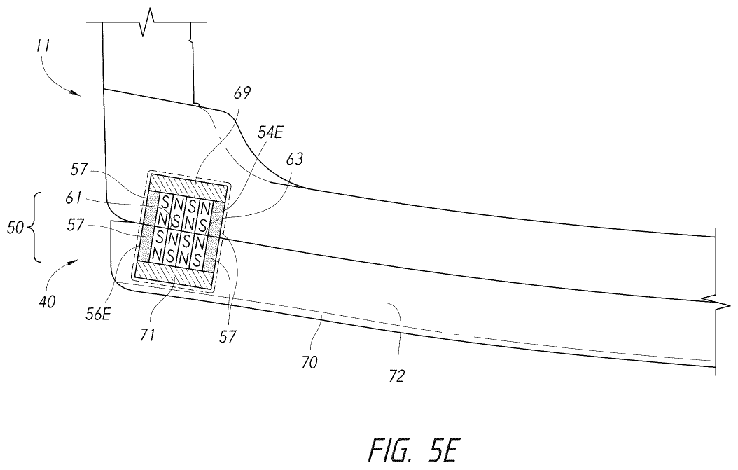

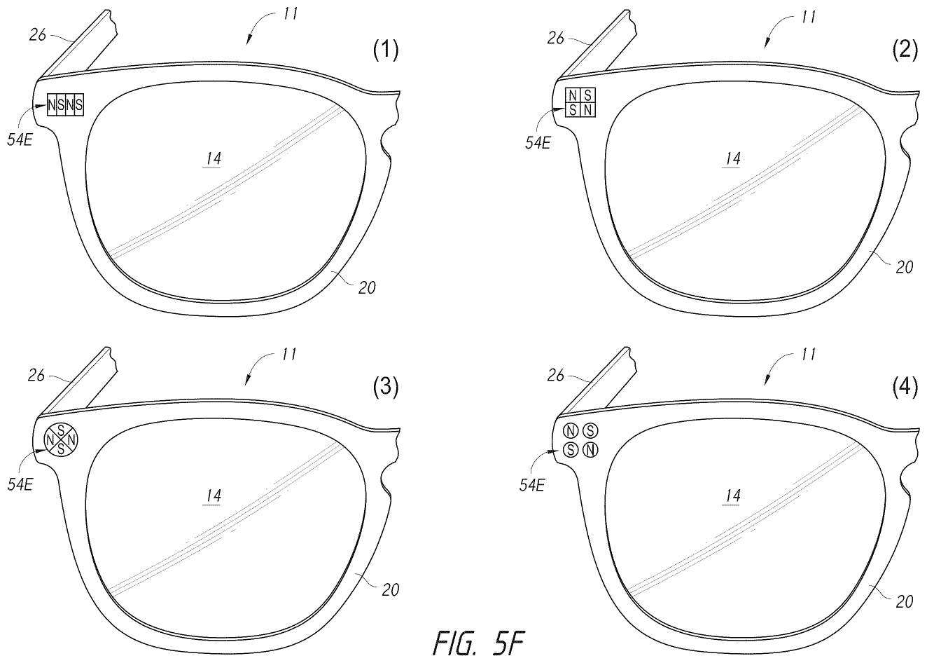

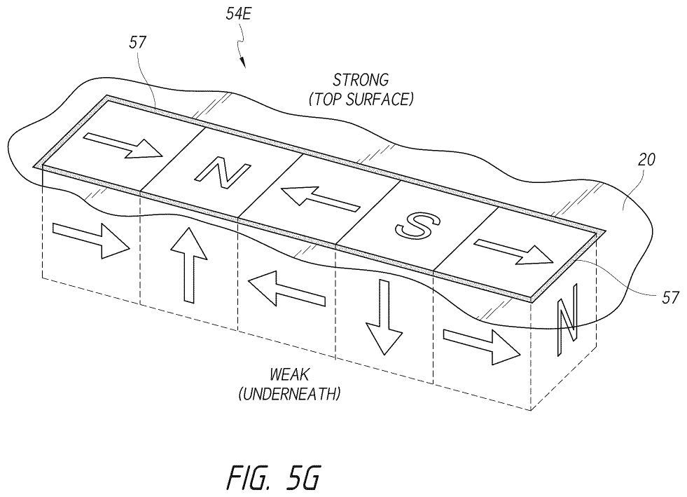

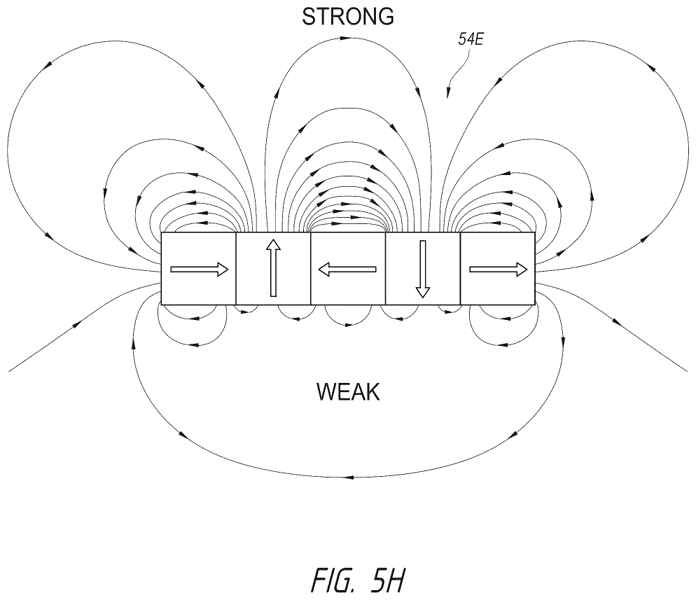

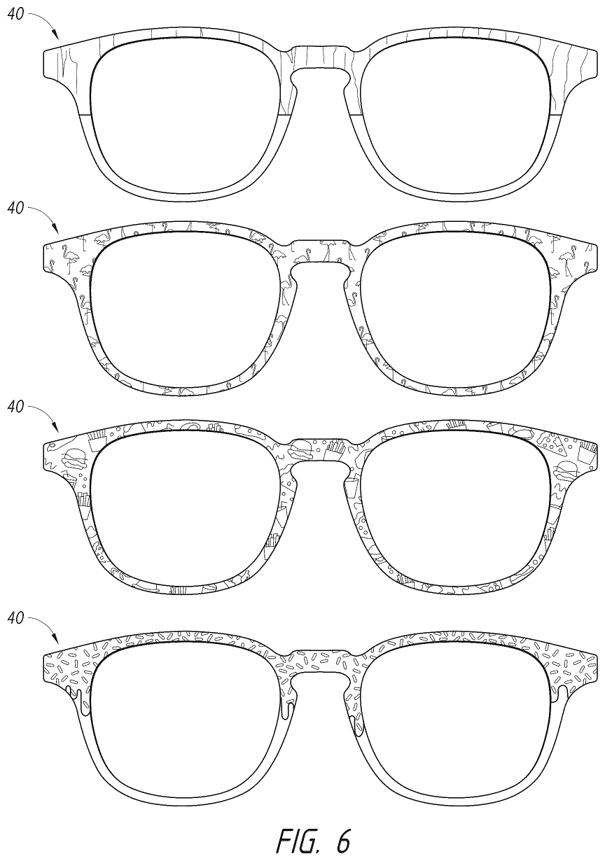

As illustrated in FIGS. 5A and 5B, the shape of the magnets 54A and 56A that form a magnetic coupling can affect the magnetic force created per unit area of exposed magnetic surface on the outside of the eyewear 10. For example, in some embodiments, it may be desirable to provide a magnetic coupling formed of a pair of magnets 54A and 56A that each includes an external magnetic interface surface 61, 63 that has a smaller width or surface area than an internally positioned opposite end surface 57, 59 of each respective magnet 54A, 56A. Sloping or tapering sides 65, 67 can be provided between the respective external and internal surfaces 61, 63, 57, 59. As shown, in some embodiments, the magnets 54A, 56A can be generally conically shaped or generally trapezoidal in shape.

As shown in part (1) of FIG. 5B, a typical rectangular permanent magnet includes a north pole and a south pole. Magnetic field lines emanate from the north pole to the south pole. As shown in part (2) of FIG. 5B, when two rectangular permanent magnets are moved near each other, an attractive force is created between opposing poles of each magnet. The density of the magnetic field lines represents the magnitude of the attractive force created between these two magnets 54A, 56A. As shown in part (3) of FIG. 5B, when the respective external magnetic interface surfaces 61, 63 are smaller in surface area or narrower in width than the surface area or width of the opposite end surfaces 57, 59 of each of such magnets, the field lines extending between the respective external magnetic interfaces surfaces 61, 63 become more dense, increasing the magnetic attractive force created between these magnets.

Various other magnets with non-square, non-rectangular, and/or non-symmetrical (in one or a plurality of planes) shapes can be used to increase the force required to remove the front frame 40 from the base frame 11, thus diminishing the risk that the front frame 40 unintentionally disconnects from the base frame 11 during storage, carrying, and use. Moreover, as illustrated, providing a smaller exposed magnetic surface can improve the aesthetic appearance of the eyewear 10 without diminishing the attractive force produced between the base frame 11 and the front frame 40.

In some embodiments, as shown, the respective holes in the components of the eyewear 10 in which the magnets 54A, 56A are positioned can be square or rectangular, even though the magnets themselves 54A, 56A are not. The width of the respective holes can be about the same as, or slightly smaller or slightly larger than, the width of the largest dimension of the respective magnets 54A, 56A to be placed into the hole. The external magnetic interface surfaces 61, 63 can be positioned essentially flush with the external surface of the respective base frame 11 or front frame 40 into which the magnets 54A, 56A are positioned, such that the external magnetic interface surfaces 61, 63 can contact each other along their perimeters or on essentially all of their respective surface areas when the base frame 11 and front frame 40 are coupled together.

The magnets 54A, 56A can be held in place by various means. For example, adhesive can be applied between the respective internally positioned opposite end surface 57, 59 of each magnet 54A, 56A and the bottom of the hole into which they are placed. In addition or in the alternative, after the magnets 54A, 56A are placed in their respective holes, an adhesive and/or blocking substance 57 can be positioned around the magnets 54A, 56A to fix them in position. For example, the region in the holes not occupied by the magnets 54A, 56A can be filled with adhesive, resin, epoxy, or any other suitable substance. In some embodiments, the walls of the holes can be sized and shaped to very closely match the shape of each respective magnet 54A, 56A to accomplish a tight friction fit. The force required to withdraw the magnets 54A, 56A in such situations can be substantially higher than the force required to separate the magnets 54A, 56A from each other when coupled. If the magnets are used as shown in FIG. 5A with a smaller external magnetic interface surface 61, 63 than an internally positioned opposite end surface 57, 59, it may be desirable to provide a hole with matching tapering walls. This may require inserting the magnets from an opening on the opposite side of the respective base frame 11 or front frame 40.

The magnetic field produced by a single permanent magnet can be modified in a useful way or focused, in effect, by positioning a ferromagnetic guide near the permanent magnet. For example, as illustrated in FIG. 5C, a ferromagnetic guide in the form of a ferromagnetic plate 69, 71 can be provided behind or internally farther within the respective component of the eyewear 10 from either or both of the magnets 54C, 56C. The ferromagnetic plate 69, 71 can be made of iron, steel, or any other suitable material. The ferromagnetic plate 69, 71 can have a width or surface area that is larger than the width or surface area of the magnet 54C, 56C that it is placed near or used with. The ferromagnetic plate 69, 71 can have a thickness that is less than the thickness of the respective magnet 54C, 56C that it is placed near or used with. The respective ferromagnetic plate 69, 71 can be very close to or in contact with the respective magnet 54C, 56C. In effect, this arrangement can bend the magnetic field lines closer to, and thus intensify or increase the density of magnetic flux near, the external magnetic interface surface 61, 63 (the opposite side of the magnet 54C, 56C from the side where the ferromagnetic plate is located). This can have at least two desirable advantages: (1) it creates a higher coupling force at a smaller interface between the magnets 54C, 56C; and (2) it decreases the magnetic field farther away from the magnets 54C, 56C, thus diminishing the risk of interfering with or demagnetizing other magnetized devices that may be in the vicinity of the eyewear 10 or components of the eyewear 10 during storage or carrying, such as credit cards or security badges.

As shown in FIG. 5D, in some embodiments, the ferromagnetic guide can be structured and positioned so as to accomplish, or to form part of an integral piece that accomplishes, one or more other functions in the eyewear 10. For example, as illustrated, the ferromagnetic guide can comprise a portion of a hinge 73 of the eyewear 10. The hinge 73 can include a first hinge stake 75 within the earstem 26 and a second hinge stake 73 within the front portion 12 of the base frame 11. The main bodies of the earstem 26 and the front portion 12 of the base frame 11 can be molded around the respective first and second hinge stake 75, 73, such as with insert injection molding of polymer materials. The first and second hinge stakes 73, 75 can be rotatably coupled to each other at a hinge point 79 to form a respective hinge that enables each of the earstems 24, 26 to rotate against the front portion 12 of the base eyewear 11 to render the eyewear 10 smaller for carrying and storage. In some embodiments, the ferromagnetic guide can be integrated into any other structure that performs one or more other functions in the eyewear 10, such as a housing for an electronic component, an internal metallic structure-reinforcing portion of an eyewear component, a portion of a wall of a metal frame of an eyewear, and/or any other suitable component.

As shown, the second hinge stake 73 can include a ferromagnetic guide 77 to help modify or focus the magnetic field of the magnet 54D. This arrangement can provide one or more advantages: (a) integrating the ferromagnetic guide 77 into the second hinge stake 73, diminishes the number of separate parts to be created, tracked, and put together during manufacturing; (b) the ferromagnetic guide 77 when integrated into another component of the eyewear 10, such as the second hinge stake 77, can be larger than the space constraints might otherwise dictate for a stand-alone ferromagnetic guide 69 (since it already occupies space in accomplishing another function), providing greater focusing of the magnetic field near the coupling surface.

FIG. 5E illustrates that, in some embodiments, each of the magnetic couplings can include a first magnetic array 54E attached to or carried by the front portion 12 of the base frame 11 for magnetically coupling to a second, complementary magnetic array 56E attached to or carried by the front frame 40. A first connector 50 can include a first base frame magnetic coupling 54E formed of a first base frame magnetic array, paired with a complementary first front frame magnetic coupling 56E formed of a first front frame magnetic array. A second connector on the opposite lateral side (not shown) can include a second base frame magnetic coupling formed of a second base frame magnetic array, paired with a complementary second front frame magnetic coupling formed of a second front frame magnetic array. In some embodiments, a third or fourth connector may also be provided, such as in the vicinity of the bridge or nose piece. In some embodiments, the connection between the front portion 12 of the base frame 11 and the front frame 40 is formed only by magnetic forces, and not formed by any mechanical connectors.

As illustrated, each of the magnetic arrays 54E, 56E can comprise a series of two or more discrete permanent magnet elements positioned respectively within the front portion 12 of the base eyewear 11 and the front frame 40. These permanent magnet elements can be arranged next to, proximate, adjacent to, or near each other in an orderly manner such that corresponding permanent magnet elements of opposite polarity come into contact with or are magnetically interacting in a significant way with each other when the front portion 12 of the base eyewear 11 and the front frame 40 are brought together by a wearer.

In some embodiments, each magnetic array 54E, 56E can be made of a single respective unitary piece of ferromagnetic material that is selectively magnetized in different regions or zones on the same unitary piece to produce a series or a pattern of different magnetic polarities. For example, any arrangement of magnets in this specification, including those illustrated in FIGS. 5E, 5F, and 5G can be formed as regions with different magnetic polarities on the same unitary piece of ferromagnetic material. The selective magnetization can be accomplished by a magnetic “printer” device that is configured to induce a plurality of small, narrowly focused proximate or adjacent regions of magnetic polarity in ferromagnetic materials. Each of the magnetic arrays 54E, 56E in a single magnetic coupling can be complementary to each other with magnetic polarities in corresponding regions being opposite from each other and therefore inducing local magnetic attraction force between them. Any magnetic array 54E, 56E made from a unitary ferromagnetic piece can be inserted and secured into corresponding recesses in the front frame 40 and front portion 12 of the base frame 11 as with any array 54E, 56E of discrete, separately formed magnet that are brought together to form the array.

In some embodiments, as illustrated, the discrete permanent magnets or magnetic regions in a unitary ferromagnetic material of a magnetic array 54E, 56E can be generally about the same size. In some embodiments, at least two of the discrete permanent magnets or magnetic regions in a unitary ferromagnetic material of a magnetic array 54E, 56E can have different shapes or sizes.

Magnetic arrays 54E, 56E can provide one or more advantages: (a) they can create more dense magnetic field lines or flux closer to the interfacing surface than with a single magnet of one polarity across the same surface area, producing very high attachment strength and resistance to detachment or sheer force between the front portion 12 of the base eyewear 11 and the front frame 40, and producing less magnetic interference farther from the interfacing surface; and (b) they can provide a coded attachment that will permit only certain arrangements of magnets on the front frame 40 to attached to the front portion 12 of the base eyewear 11. A coded attachment can ensure that only specified types of front frames 40 can be used with specified types of base frames 11, ensuring high quality design, manufacturing, performance, and safety standards. As with all disclosure and drawings in this specification, which can be used separately or combined, the ferromagnetic guide 69 of FIG. 5E can be integrated into a functional eyewear component such as is shown with hinge stake 73 in FIG. 5D.

A method of providing a coded magnetic attachment includes providing a base frame with a first magnetic array arranged with a first set of polarities and positions for a first plurality of permanent magnets or magnetic regions, and enabling a front frame with a corresponding second magnetic array arranged with a second set of polarities and positions for a second plurality of permanent magnets or magnetic regions to generate an attractive force with the first magnetic array when brought together, and not enabling a front frame with a non-corresponding third magnet or magnetic array to generate an attractive force with the first magnetic array when brought together.

FIG. 5F shows various examples of arrangements of permanent magnet elements that can be provided in a magnetic array 54E in the front portion 12 of the base frame 11. In part (1), which is a front plan view that corresponds to the arrangement illustrated in FIG. 5E, a magnetic array 54E is provided with an alternating series of adjacent north and south permanent magnet elements in a general linear arrangement. In part (2), a magnetic array 54E is provided in a two-dimensional matrix arrangement that essentially forms a square, with a sequence of opposing magnetic polarities of adjacent permanent magnet elements in both vertical and horizontal directions. In part (3), a magnetic array 54E is provide in an arrangement with a generally circular outer perimeter or circumference divided into a plurality (in this example, an even number of four) of adjacent generally triangular elements with alternating polarity around the perimeter or circumference. In part (4), a magnetic arrange 54E is provided with a plurality of circular permanent magnet elements that are provided in two dimensions, spaced apart from each other by a small amount with alternating polarities, the spacing being less that the width of each permanent magnet element. Each of parts (1)-(4) include four permanent magnet elements but any number can be used in suitable arrangements. In some embodiments, the polarity, arrangement, and/or positioning of the permanent magnet elements can follow all or a portion of a magnetic ordering, code, or program, such as the Halbach array (e.g., see FIGS. 5G and 5H, with the strong side positioned facing externally in one component of eyewear 10 and a corresponding opposite polarity portion positioned facing externally in the other removably attachable component of the eyewear 10). As shown, such an ordering, code, or program in some embodiments can include at least four magnets or at least five magnets. In some embodiments, the ordering, code, or program can be repeated multiple times. As with all text and drawings in this specification, any feature or pattern of any of these arrangements or any portion thereof, including in parts (1)-(4) of FIG. 5F or FIG. 5G, can be used by itself or combined with any other feature or pattern of any other arrangement, including in parts (1)-(4) of FIG. 5F or FIG. 5G, or in any other arrangement.

As shown in the examples of Parts (1)-(3) of FIG. 5F, in some embodiments there can be little or no space between proximate or adjacent magnets or magnetized polarity regions in the magnetic arrays 54E, 56E. In some embodiments, each magnet or magnetized polarity region touches or contacts one or more other magnets or magnetized polarity regions. As shown in Parts (1)-(3), in some positioning and/or orientations of the individual magnets or magnetized polarity regions, there are no magnets or magnetized polarity regions that border or are proximate or adjacent to an edge of another magnet or magnetized polarity region of the same polarity. In Part (3), some magnets or magnetized polarity regions contact, or are proximate or adjacent to, another magnet or magnetized polarity region of the same polarity at essentially a point, but not a border or full edge. In Part (4), none of the magnets or magnetized polarity regions are adjacent to another magnet or magnetized polarity region. In some embodiments, as illustrated in Part (4), whatever space may exist between adjacent or proximate magnets or magnetized polarity regions, whether of the same or opposite polarity, such space can be less than (or equal to) the width of one of the magnets or magnetized polarity regions itself.

In some embodiments, the magnetic arrays 54E, 56E can be very small, as illustrated in FIG. 5F. For example, each magnetic array with all magnets and/or variations in magnetic polarity for each respective magnetic array 54E, 56E can be positioned within less than or equal to about 1 cm² or within less than or equal to about 0.25 cm². As shown in FIG. 5F, the entire respective magnetic array 54E, 56E of each magnetic coupling can be positioned in a respective upper lateral corner of an eyewear orbital, either on the front portion 11 of the base frame 12 or the front frame 40. In some embodiments, as shown, there can be five or less, or four or less, discrete magnets or magnetic polarity regions in each respective magnetic array 54E, 56E, such that the total number of discrete magnets or magnetic polarity region of the two magnetic coupling portions of the respective anterior surface of the front portion 12 of the base eyewear 12 or the posterior surface of the front frame 40 is 10 or less, or 8 or less. In some embodiments, the rest of the surface area of the anterior surface of the front portion 11 of the base frame 12 and the posterior surface of the front frame 40 can be non-magnetic. In some embodiments, a majority of the rest of the surface area of the anterior surface of the front portion 11 of the base frame 12 and the posterior surface of the front frame 40 can be non-magnetic. In some embodiments, as shown, there are no magnetic surfaces positioned vertically below the earstems 24, 26 of the eyewear 10, and there are no magnetic surfaces positioned vertically above and/or below either of the lenses 14, either in the front portion 12 of the base frame 11 and/or in the front frame 40 when attached to the front portion 12 of the base frame 11.

In some embodiments, there can be many advantages of positioning or focusing the magnetic couplings in one, two, or more very small regions and not across the entire respective anterior or posterior surfaces of the respective front portion 12 of the base eyewear 11 or front frame 40: (a) less components and manufacturing cost; (b) more room for design aesthetics and flexibility; and (c) less magnetic interference created surrounding the eyewear components when carried or stored.

Many other possibilities of arrangements of permanent magnet elements are contemplated and can be used. For each example or implementation, a corresponding magnetic array 56E in the front frame 40 with corresponding opposite magnetic polarity for each permanent magnet element in the front portion 12 of the base eyewear 11 can be provided for removable attachment. In each example of FIG. 5F, only one lateral side of the front portion 12 of the base frame 11 is shown. The arrangement and polarity of the permanent magnet elements on the opposite lateral side of the front portion 12 of the base frame 11 can be opposite, a mirror image, or can be different in other ways. In each instance the front frame 40 can include corresponding opposite-polarity arrangements of permanent magnet elements in corresponding locations on the posterior surface of the front frame 40 to induce magnetic attraction at each magnet location and to permit the front frame 40 to attach securely to the front portion 12 of the base frame 11 such that the respective outer perimeters of each of the front portion 12 of the base frame 11 and the front frame 40 are generally aligned and generally in contact along the majority of or the entirety of their respective edges.

The arrays of permanent magnet elements can be provided and/or positioned in the components of the eyewear 10 in any suitable way, such as by adhering discrete permanent magnets to each other and/or inserting them into and/or adhering them to the corresponding eyewear components. The magnetic elements can be deposited or printed on a substrate or backing layer and then inserted into the corresponding hole in the respective eyewear component, or deposited or printed directly into the corresponding hole in the respective eyewear component.

In any embodiment, the strength of the connection between the base frame 11 and the front frame 40 can be sufficiently high to resist unintended disconnection in normal daily usage. For example, if the eyewear 10 is dropped from the average height of an adult, it is desirable that the jarring impact force on the eyewear 10 against the ground would not be sufficient to disconnect the front frame 40 from the base frame 11. Likewise, when the eyewear 10 is inserted or slid into or stored within an eyewear case, or a pocket, purse, brief case, suit case, backpack, or other standard storage or carrying receptacle, it is desirable that the forces against the eyewear 10 applied by the storage or carrying receptable and the normal jostling or movement against other stored articles within the storage or carrying receptacle in daily use would not be sufficient to disconnect the front frame 40 from the base frame 11. For example, in some embodiments, the force required to remove the front frame 40 from the base frame 11 can be at least about 0.5 N, or between about 0.25 N and about 3 N. If the eyewear 10 includes two connectors 50, 52 each comprising two magnetic couplings or two arrays of magnetic couplings 54, 56, 58, 60, then each connector can provide approximately half of the force required to retain the front frame 40 from the base frame 11. In some situations, such as where the front frame 40 includes heavy components, including optical elements and/or one or more electronic components, the force required to remove the front frame 40 from the base frame 11 can be larger, such as at least about 2 N, or between about 1.5 N and about 3 N. It is desirable not to make the force so high as to be inconvenient or difficult for a user when the front frame 40 is removed or switched, such as would require prying the front frame 40 from the base frame 11 with a fingernail or a tool.

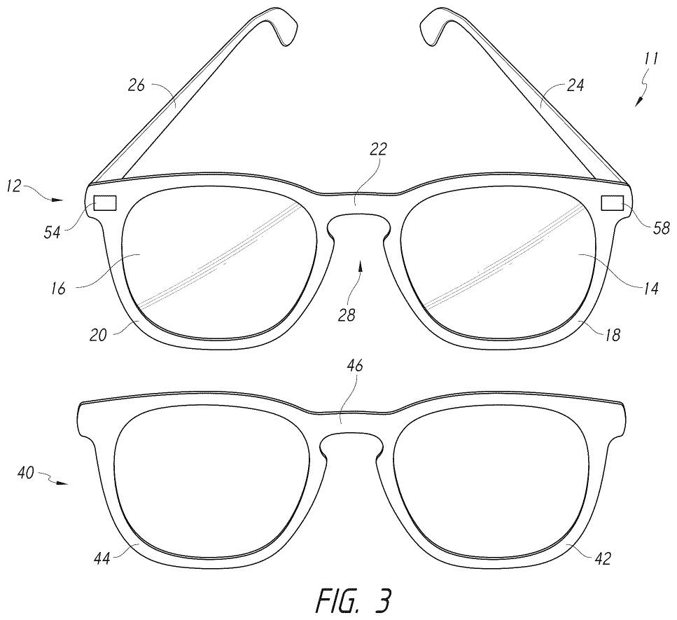

As shown in FIGS. 3-5, in some embodiments, a “complete” front frame 40 can comprise two full, continuous, and/or uninterrupted orbitals that are positioned anterior from and that extend around the perimeter of (or around substantially the entire perimeter of) the lenses held in place by the orbitals of the underlying front portion 12 of the base frame 11. As shown, in some embodiments, a complete front frame 40 can be attached to the front portion 12 of the base frame 11 by only or no more than two magnetic arrays on the front portion 12 of the base frame 11 and only or no more than two magnetic arrays on the front frame 40, without requiring any additional magnets or magnetic couplings to securely and tightly hold the front frame 40 to the front portion 12 of the base frame 11.

As illustrated, in some embodiments, each of the two sets of magnetic couplings can be positioned only on the outer, upper lateral sides and/or edges of each orbital on each of the front portion 12 of the base frame 11 and the front frame 40. Providing only two sets of magnetic couplings can create one or more advantages in certain embodiments, including: (a) diminishing the number of parts in manufacturing and therefore the cost and weight of the product; and (b) diminishing the unaesthetic appearance of more than two magnets being visible on the front portion 12 of the base frame 11 when the front frame 40 is not attached, permitting a user to wear the front portion 12 of the base frame 11 by itself without a front frame 40 at times, if desired. As shown, in some embodiments, there are no magnets positioned below the upper portion or the upper half of the front frame 40, and/or there are no magnets positioned in a region of the front frame 40 (when attached to the front portion 12 of the base frame 11) that is below the bottom edge of the anterior end of either of the earstems 24, 26, and/or there are no magnets positioned on either bridge 22, 46. In some embodiments, as shown, all magnets on the front portion 12 of the base frame 11 can be positioned on the vertical anterior surface of the front portion 12 of the base frame 11, and all magnets on the front frame 40 can be positioned on the vertical posterior surface of the front frame 40; and/or no magnets are provided on any horizontal surfaces and/or on any other components or surface of the front portion 12 of the base frame 11, the front frame 40, and/or the earstems 24, 26.

In some embodiments, the front frame 40 can comprise one or more neodymium magnets that are securely attached to or embedded in the posterior surface of the front frame 40. Via magnetic attractive force, the top frame can be removably attached to the front portion 12 of the base frame 11 that can also feature corresponding one or more neodymium magnets that are securely attached to or embedded in the anterior surface of the front portion 12 of the base frame 11. In some embodiments, each of the respective magnets of the front frame 40 and/or front portion 12 of the base frame 11 can be positioned within the front frame 40 and/or front portion 12 of the base frame 11 at a depth that is less than or equal to about 1.2 mm and/or is greater than or equal to about 0.4 mm. In some embodiments, one or more of the magnets or magnetic arrays in the front portion 12 of the base frame 11 and/or front frame 40 are attached by providing a corresponding hole or recess within the surface of the front portion 12 of the base frame 11 and/or front frame 40 that is about the same as the thickness and/or cross-sectional width or diameter of the magnet. In some embodiments (not shown), a hole extending entirely through a component of the eyewear 10 (e.g., the front portion 12 of the base frame 11 or the front frame 40) can have a smaller opening on one side than the other side. In this way, a magnet or magnetic array that is smaller on one side than the other can be inserted into the larger side of the hole during manufacturing or assembly. Upon insertion, the smaller side of the magnet or magnetic array can be sized to fit tightly into the smaller side of the hole such that there is little if any space surrounding the smaller side of the magnet or magnetic array between eyewear component and the magnet or magnetic array.

During manufacturing or assembly, the magnet or magnetic arrays can be held in place by a frictional force fit within the hole and/or the magnet or magnetic arrays can be held in place with an adhesive. As shown, the posterior outer surface of the magnet or magnetic arrays when positioned in the front frame 40 and/or the anterior outer surface of the magnet or magnetic arrays when positioned in the front portion 12 of the base frame 11 can be essentially flush with the respective surfaces of the front portion 12 of the base frame 11 and/or the front frame 40 that is or are generally adjacent to and/or generally surrounding the magnet or magnetic arrays. For example, in some embodiments, the magnet or magnetic arrays do not protrude out appreciably from the surfaces of the front frame 40 and/or the front portion 12 of the base eyewear in which the magnet or magnetic arrays are positioned or inserted.

In some embodiments, any one or more components of the eyewear system, including the front portion 12 of the base frame 11, earstems 24, 26, and/or the front frames 40 can be constructed from a composition that includes a polymer, such as a thermoplastic amorphous polyamide (e.g., TR90). In some embodiments, any one or more components of the eyewear system, including the base frame 11 and/or the front frame 40 may be constructed of a composition that includes a metal and/or alloy, such as, but not limited to, aluminum, stainless steel, iron, titanium, monel, beryllium, and or nickel silver. In some embodiments, the base frame 11 and/or front frame 40 may be constructed of a material that is ferromagnetic. In some embodiments, the front portion 12 of the base frame 11 and/or the front frame 40 do not include any metallic component, metallic layer, or ferromagnetic material, except for the discrete magnets or magnetic arrays positioned in the respective upper laterally outward corners of the front frame 40. The front frame 40 may be formed of multiple anterior and posterior layers having different opacities. For example, the front frame 40 can be provided with an opaque anterior layer 70 and a generally transparent posterior layer 72. As shown, the opaque layer 70 can be substantially thinner than the transparent posterior layer 72.

As illustrated in FIG. 4, either or both of the front portion 12 of the base frame 11 and/or the front frame 40 can be non-flat, non-planar, non-straight, and/or curved. In some embodiments, as shown, a curved surface on either or both of the front portion 12 of the base frame 11 and/or the front frame 40 can include one or more discrete regions with one or more separate or distinct curvatures. In some embodiments the curvature can exist in a horizontal plane, or in a vertical plane, or in both horizontal and vertical planes. The one or more curved surfaces can be separate from each other but of about the same size and/or type of curvature, or the curved surfaces can be separate from each other and of different sizes and/or types of curvature. For example, as illustrated, the front portion 12 of the base frame 11 can include a first curvature along a first region (e.g., on the first orbital 18), a second curvature along a second region (e.g., on the bridge 22), and a third curvature along a third region (e.g., on the second orbital 20). As shown, the first curvature in the first region can be essentially the same size and type (e.g. generally spherical or generally cylindrical) as the third curvature in the third region, and the second curvature in the second region can be different from the first and/or second curvatures. For example, as illustrated, the second curvature can have a smaller radius than the curvature in the first and third regions but can be of the same type (e.g., generally cylindrical or generally spherical). Similarly, as illustrated, the front frame 40 can include a first curvature along a first region (e.g., on the first orbital 42), a second curvature along a second region (e.g., on the bridge 46), and a third curvature along a third region (e.g., on the second orbital 44). As shown, the first curvature in the first region can be essentially the same size and type (e.g., generally spherical or generally cylindrical) as the third curvature in the third region, and the second curvature in the second region can be different from the first and second curvatures. For example, as illustrated, the second curvature of the front frame 40 can have a smaller radius than the curvature in the first and third regions of the front frame 40 but can be of the same type (e.g., generally cylindrical or generally spherical).

As illustrated in FIGS. 4 and 5, when the top frame 40 is removably attached to the front frame 12, the corresponding curved surface or surfaces of each of the front frame 12 and the top frame 40 can be generally the same or essentially the same size and shape in the regions that are brought proximal to each other or made to contact with each other. For example, as shown in FIG. 5, when the top frame 40 and the front frame 12 are removably attached, the respective one or more curved surfaces can generally or substantially correspond, match, fit within, nest, and/or conform to each other in a sufficiently close manner that essentially no space, gap, and/or distance exists between them generally, substantially, or entirely along their respective perimeters. For example, the anterior surface of the front portion 12 of the base frame 11 can contact or closely fit with the posterior surface of the front frame 40 along generally all or substantially all of the perimeters of one or more or all regions or the front portion 12 of the base frame 11 and the front frame 40. In some embodiments, as shown, there can be a slight protrusion on the anterior surface of the front portion 12 of the base frame 11 caused by the bridge 22 and a corresponding slight recess on the posterior surface of the front frame 40 to closely or tightly receive the protrusion on the front portion 12 of the base frame 11. Some embodiments of any of these arrangements can provide one or more advantages, such as: (a) a tight, snug, and/or secure fit between the front portion 12 of the base frame 11 and the front frame 40, especially against undesired lateral or vertical movement; (b) a resistance to the passage of light, air, and/or debris between the front portion 12 of the base frame 11 and the front frame 40; and/or (c) an integral appearance between the front frame 40 and the front portion 12 of the base frame 11 such that these two components upon casual observation from one or more or all sides or angles can appear to be one component.

As shown in FIG. 4A, in some embodiments the front frame 40 can be substantially thinner than the front portion 12 of the base frame 11 in one or more or all regions, as measured between the respective anterior and posterior surfaces of each of the front frame 40 and front portion 12 of the base frame 11. For example, in some embodiments, the front portion 12 of the base frame 11 can be at least about twice as thick as the front frame 40. In some implementations, the front frame 40 can be less than or equal to about 3 mm or less than or equal to about 2 mm in thickness. Similarly, in some embodiments, the front frame 40 can be lighter than the front portion 12 of the base frame 11. For example, the front portion 12 of the base frame 11 can be at least about twice as heavy as the front frame 40. The lighter weight of the front frame 40 as compared to the front portion 12 of the base frame 11 can result from the front frame 40 being thinner and therefore having less mass, and/or being made from a lighter material, and/or lacking one or more lenses. As shown, the thickness of the front frame 40 and/or the thickness of the front portion 12 of the base frame 11 can be constant or substantially constant across the entire front frame 40 and/or front portion 12 of the base frame 11. As shown, in some embodiments, no portion of the front frame 40 extends into the base frame 11, and/or no portion of the base frame 11 extends into the front frame 40, when the front frame 40 is attached to the front portion 12 of the base frame 11. In some embodiments, thinner and/or lighter front frames 40 can provide one or more advantages: (a) a lower likelihood of unintended detachment of the front frame 40 from the front portion 12 of the base frame 11; (b) less weight on a user's face; (c) lower manufacturing cost; and/or (d) easier and more convenient storage and carrying of one or more interchangeable front frames 40. In some embodiments, the front frame 40 is highly bendable, resilient, and/or flexible, enabling the front frame 40 to tolerate normal daily movements, wear, dropping, or even normal stepping or crushing forces, without causing damage to the structural integrity of the front frame 40 and/or without materially or permanently changing the shape of the front frame 40.

As illustrated in FIG. 5, some embodiments can enable attachment between the front portion 12 of the base frame 11 and the front frame 40 only by magnetic attraction and without requiring any mechanical coupling. As shown, in some embodiments, no part of the front frame 40 extends in a posterior, backward, and/or rearward direction past the anterior surface of the front portion 12 of the base frame 11 when the front frame 40 is attached to the base frame 11. All portions of the front frame 40 when attached to base frame 11 can be positioned in front of the posterior surface of the base frame 11.

In some embodiments, each of the main system parts can exhibit a mechanical curvature, these curvatures are matched mechanically to provide a “fit” between the anterior surface of the top and the posterior surface of the base that enables the magnetic bond to exhibit a significant, measurable resistance to shearing forces and allows for no visible space between the surfaces upon casual observation. For example, by providing an anterior surface on the front frame 12 and a posterior surface on the top frame 40 that generally or substantially correspond, match, fit within, nest, and/or conform to each other, the respective coupling outer faces of the magnets on the front portion 12 of the base frame 11 and the magnets on the front frame 40 can be positioned in a generally coplanar orientation with each other when attached, providing maximum or full contact between the outer faces of the respective coupling magnets to induce maximum or full magnetic attractive forces. In some embodiments, as shown, no part of the front frame 40 is required to be bent, stretched, contorted, or twisted in order to attach and/or remove the front frame 40 to or from the front portion 12 of the base frame 11.

In some embodiments, the material of which the front frame 40 is made is generally more flexible and more impact resistant than the material of which the base frame 11 is made. In some embodiments, the Young's modulus of a TR90 front frame 40 can be less than an acetate front frame 40, having overall more elasticity.

The magnets (e.g., neodymium N52 magnets) can be embedded or otherwise attached to or positioned in the respective posterior surface of the top frame 40 and the anterior surface of the front frame 12. The magnets can have any shape or size to provide a suitable attachment force to maintain the top frame 40 in place during normal activities but that is not overly difficult to remove by a user when desired. In some embodiments, the magnets are very small, for example less than or equal to about 7 mm in diameter or cross-sectional width, and/or less than or equal to about 7 mm in diameter or cross-sectional width, and/or about 5 mm in diameter or cross-sectional width. In some embodiments, the magnets can be very thin, such as less than or equal to about 2 mm in thickness, and/or less than or equal to about 1.5 mm in thickness, and/or about 1.2 mm in thickness.

In some embodiments, the magnets can be precision placed at about 0.47 mm from the anterior surface with about a ±0.03 mm tolerance but may be placed at about 0.6 mm but no more than about 0.1 mm with a tolerance of a ±0.03 mm. The magnet(s) in the top frame can be placed so that the posterior side of the N52 magnet in the top frame is exposed and is generally even with the final layer of the posterior surface. The magnetic poles of the front portion 12 of the base frame 11 and the front frame 40 can be always oriented in the same direction, meaning if the attracting poles are inward-facing on the front frame 40 and outward-facing on the front portion 12 of the base frame 11 then this can be consistent across all styles and all front frames 12 and all front frames 40. This provides predictability and compatibility when attaching a front frame 40 to a front portion 12 of the base frame 11.

In some embodiments, a high-strength but conveniently removable magnetic coupling can be provided between the front portion 12 of the base frame 11 and the front frame 40 to resist unintentional decoupling, loss of or damage to the front frame 40, and/or appreciable gaps between the front portion 12 of the base frame 11 and the front frame 40. In magnetics, the strength of a permanent magnet can be measured using the maximum energy product, which is typically measured in units of either kJ/m3 (kilojoules per cubic meter) or MGOe (mega-gauss-oersted). The maximum energy product represents the density of magnetic energy in the material. In some embodiments, the respective magnets provided in the front frame 12 and/or top frame 40 can have a maximum energy product of at least about 40 MGOe and/or less than or equal to about 60 MGOe (between about 320 KJ/m3 and about 480 KJ/m3), or at least about 48 MGOe and/or less than or equal to about 52 MGOe (between about 380 KJ/m3 and about 415 KJ/m3).

The pull force is a measure of the force required to decouple the front frame 40 from the front portion 12 of the base frame 11 by pulling the front frame 40 forward, in an anterior direction away from the wearer's face. When comparing magnets of a given shape, the pull force of the magnetic material is generally proportional to the maximum energy product, sometimes referenced as the N-number. In some embodiments, the respective magnets located in or on the front portion 12 of the base frame 11 and/or front frame 40 can each create a magnetic pull force that is at least about 0.1 N and/or less than or equal to about 50N (between about 0.02 lbf and about 11.24 lbf), at least about 1.0 N and/or less than or equal to about 25 N (between about 0.22 lbf and about 5.62 lbf), or at least about 3.0 N and/or less than or equal to about 10.0 N (between about 0.67 lbf and about 2.25 lbf). In some embodiments, when the respective magnets are attached to and/or embedded in the front portion 12 of the base frame 11 and/or the front frame 40, the sheer force required to slide each respective, individual magnet in the front frame 40 away from the corresponding individual magnet to which it is coupled in the front portion 12 of the base frame 11 (by shifting these parts from each other laterally, vertically, and/or horizontally) can be at least about 0.1 N and/or less than or equal to about 50 N, at least about 0.2 N and/or less than or equal to 10 N, or at least about 0.5 N and/or less than or equal to 3.0 N. The N-type can be specified with a prescribed holding force and controlled for quality and consistency.

The following is claimed:

1. An eyewear system comprising:
a base frame with a front portion comprising an anterior surface and a posterior surface, at least one lens, and left and right earstems attached to the front portion of the base frame; and
a front frame configured to be positioned in front of the front portion of the base frame; and
wherein the front frame is releasably connectable to the base frame by a plurality of magnetic couplings, each of the plurality of magnetic couplings comprising at least one magnet with an exposed external surface and a recessed internal surface on an opposite side, the exposed external surface having a smaller width than the recessed internal surface.

2. The eyewear of claim 1, wherein the at least one magnet of the plurality of magnetic couplings is trapezoidal.

3. The eyewear of claim 1, wherein the at least one magnet of the plurality of magnetic couplings is conical.

4. The eyewear of claim 1, wherein the front frame comprises a left lens disposed within the left opening and a right lens disposed within the right opening.

5. An eyewear system comprising:
a base frame with a front portion comprising an anterior surface and a posterior surface, at least one lens, and left and right earstems attached to the front portion of the base frame; and
a front frame being configured to be positioned in front of the base frame; and
wherein the front frame is releasably connectable to the base frame by a plurality of magnetic couplings, at least one of the magnet couplings comprising at least one magnet and a ferromagnetic guide in the form of a plate positioned in a recess in either the base frame or the front frame, the plate positioned further within the recess than the magnet.

6. The eyewear system of claim 5, wherein the ferromagnetic guide is integrated into a component in the eyewear system that performs another eyewear function.

7. The eyewear system of claim 6, wherein the ferromagnetic guide is integrated into a hinge stake.

8. An eyewear system comprising:
a base frame with a front portion comprising an anterior surface and a posterior surface, at least one lens, and left and right earstems attached to the front portion of the base frame; and
a front frame being configured to be positioned in front of the front portion of the base frame; and
wherein the front frame is releasably connectable to the base frame by a plurality of magnetic couplings comprising a first array of permanent magnets adjacent to each other positioned in a recess on one of the front frame or the base frame, and a corresponding second array of permanent magnets adjacent to each other positioned in a recess on the other of the front frame or the base frame, the second array of permanent magnets having polarities configured to produce an attractive force with the first array of permanent magnets.

9. The eyewear system of claim 8, wherein the first and second array of permanent magnets are programmable such that the first array of permanent magnets can be programmed to have a first configuration of polarities and the second array of permanent magnets can be programmed to have a second configuration of polarities, the second configuration of polarities being opposite to the first configuration of polarities.

10. The eyewear system of claim 8, wherein the first and second array permanent magnets are configured such that the attractive force between the first array of permanent magnets and the second array of permanent magnets is only produced when the front frame is connected to the base frame in a first orientation.

11. The eyewear system of claim 8, wherein the second array of permanent magnets only produces an attractive force with the first array of permanent magnets when the second array of permanent magnets has a first configuration of polarities that is opposite to the configuration of polarities of the first array of permanent magnets.
